(19) United States
(12) Patent Application Publication
(10) Pub. No.: US 2014/0104534 A1
(43) Pub. Date: Apr. 17, 2014

(54) PAUS1211876_CH12193

(71) Applicant: Gang Yu, Shenzhen City (CN)

(72) Inventor: Gang Yu, Shenzhen City (CN)

(73) Assignee: Shenzhen China Star Optoelectronics Technology Co. Ltd., Shenzhen, Guangdong (CN)

(21) Appl. No.: 13/642,987

(22) PCT Filed: Oct. 15, 2012
(86) PCT No.: PCT/CN12/82975

§ 371 Date: Dec. 6, 2012

(30) Foreign Application Priority Data
Oct. 11, 2012 (CN) 201210384371.5

(51) Int. Cl. G02F 1/1335; G09F 13/04

(52) U.S. Cl. CPC G02F 1/133608; G09F 13/04
USPC 349/58; 362/97.1

(57) ABSTRACT

The present invention provides a backlight module which comprises a backboard, an optical film, and a positioning device. At least a positioning device being arranged on a perimeter of the backboard and extending upward form a top surface of the backboard, wherein a peripheral of the optical film is provided with at least a tab having a retaining opening defined therein to envelop onto the positioning device. And wherein the tab, distant to a center of the optical film inherited with intensity stronger than other portions of the optical film. By this arrangement, the reliability of the positioning of the optical film is ensured, and this is specially suitable for the design of narrow-boarder.

### FIELD OF THE INVENTION

The present invention relates to a technology of liquid crystal display, and more particularly, to a liquid crystal display device and a backlight module incorporated within the liquid crystal display device.

### BACKGROUND OF THE INVENTION

True positioning of an optical film within a backlight module can greatly affect the optical quality of the backlight module. Referring to FIGS. 1 and 2. FIG. 1 is a perspective view of a backlight module 10 made in accordance with the present invention. FIG. 2 is an enlarged view of an optical film 12 encircled portion A of FIG. 1. In the current practice, the optical film 12 is defined with a plurality of positioning holes 120 along its peripheral, and the backboard 11 is provided with a plurality of positioning wedges 13 matching with the positioning holes 120. With the interengagement between the positioning holes 120 and the wedges 13, the optical film 12 is secured thereto.

It has been found by the inventor over a long period of observation that a hanger 121 of the optical film 12 becomes smaller and smaller and its intensity can not be ensured. As a result, the reliability of the optical film 12 is jeopodarized.

### SUMMARY OF THE INVENTION

In order to resolve the technical issues encountered by the prior art, the present invention provides a backlight module and a liquid crystal display device incorporated with the backlight module. The reliability of the reflector within the backlight module can be ensured, and the utilization of the light is also upgraded. The present invention is specially suitable for the narrow-boarder design.

In order to resolve the technical issue encountered by prior art, the present invention provides a technical solution by introducing a backlight module comprises a backboard, an optical film, and a positioning device. At least a positioning device being arranged on a perimeter of the backboard and extending upward form a top surface of the backboard, wherein a peripheral of the optical film is provided with at least a tab having a retaining opening defined therein to envelop onto the positioning device. Wherein the backlight module further includes an enhancing frame matched to the tab and arranged thereunder or thereabove making the tab, distant to a center of the optical film, inherited with intensity stronger than other portions of the optical film. And wherein the enhancing frame is attached to the top or bottom surfaces of the tab.

Wherein the material used to make the enhancing frame is polyethylene terephthalate.

Wherein the tab is glued to the peripheral of the optical film, and the tab has intensity stronger than the optical film.

Wherein the tab is made from polyethylene terephthalate.

In order to resolve the technical issue encountered by prior art, the present invention provides a technical solution by introducing a backlight module comprises a backboard, an optical film, and a positioning device. At least a positioning device being arranged on a perimeter of the backboard and extending upward form a top surface of the backboard, wherein a peripheral of the optical film is provided with at least a tab having a retaining opening defined therein to envelop onto the positioning device. And wherein the tab distant to a center of the optical film, inherited with intensity stronger than other portions of the optical film.

Wherein the backlight module further includes an enhancing frame matched to the tab and arranged thereunder or thereabove making the tab, distant to a center of the optical film, inherited with an intensity stronger than other portions of the optical film.

Wherein the material used to make the enhancing frame is polyethylene terephthalate.

Wherein the tab is glued to the peripheral of the optical film, and the tab has intensity stronger than the optical film.

Wherein the tab is made from polyethylene terephthalate.

In order to resolve the technical issue encountered by prior art, the present invention provides an technical solution by introducing a liquid crystal display device comprises a displaying panel, and a backlight module disposed below the displaying panel The backlight module comprises a backboard, an optical film, and a positioning device. At least a positioning device being arranged on a perimeter of the backboard and extending upward form a top surface of the backboard, wherein a peripheral of the optical film is provided with at least a tab having a retaining opening defined therein to envelop onto the positioning device. And wherein the tab, distant to a center of the optical film, inherited with intensity stronger than other portions of the optical film.

Wherein the backlight module further includes an enhancing frame matched to the tab and arranged thereunder or thereabove making the tab, distant to a center of the optical film, inherited with an intensity stronger than other portions of the optical film.

Wherein the material used to make the enhancing frame is polyethylene terephthalate.

Wherein the tab is glued to the peripheral of the optical film, and the tab has intensity stronger than the optical film.

Wherein the tab is made from polyethylene terephthalate.

The present invention can be concluded with the following advantages. As compared with the prior art, the tab of the optical film can be readily enhanced by the enhancing frame so as to increase and upgrade the intensity of the tab. By this arrangement, the hanger of the tab is intensified, and the positioning of the optical film is ensured, and this is specially suitable for the design of narrow-boarder.

### BRIEF DESCRIPTION OF DRAWINGS

FIG. 1 is a perspective view of a backlight module made in accordance with the present invention;

FIG. 2 is an enlarged view of art optical film encircled portion A of FIG. 1;

FIG. 3 is an assembled and perspective view of a backlight module made in accordance with a first embodiment of the present invention;

FIG. 4 is an enlarged view of an encircled portion 8 shown in FIG. 3;

FIG. 5 is a cross sectional view of an optical film and an enhancing Frame after assembly in accordance with a first embodiment of the present invention;

FIG. 6 is an assembled view of s backlight module made in accordance with a second embodiment of the present invention;

FIG. 7 is an enlarged view of an encircled portion C of an optical film shown in FIG. 6;

FIG. 8 is a cross sectional view of the optical film and the tab after assembly in accordance with a first embodiment of the present invention; and

FIG. 9 is a cross sectional view of a liquid crystal display device made in accordance with the present invention.

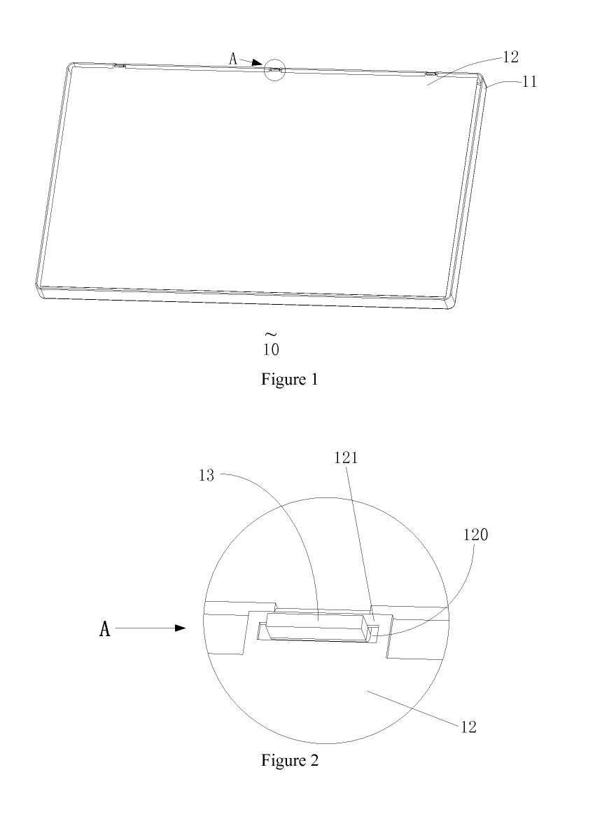

### DETAILED DESCRIPTION OF PREFERRED EMBODIMENTS

In order to give a better and thorough understanding to the whole and other intended purposes, features and advantages of the technical solution of the present invention, detailed description will be given with respect to preferred embodiments provided and illustrated herebelow in accompanied drawings. Apparently, with the spirit of the embodiments disclosed, person in the skilled in the art can readily come out with other modifications as well, as improvements without undue experiment. In addition, other drawings can be readily achieved based on the disclosed drawings.

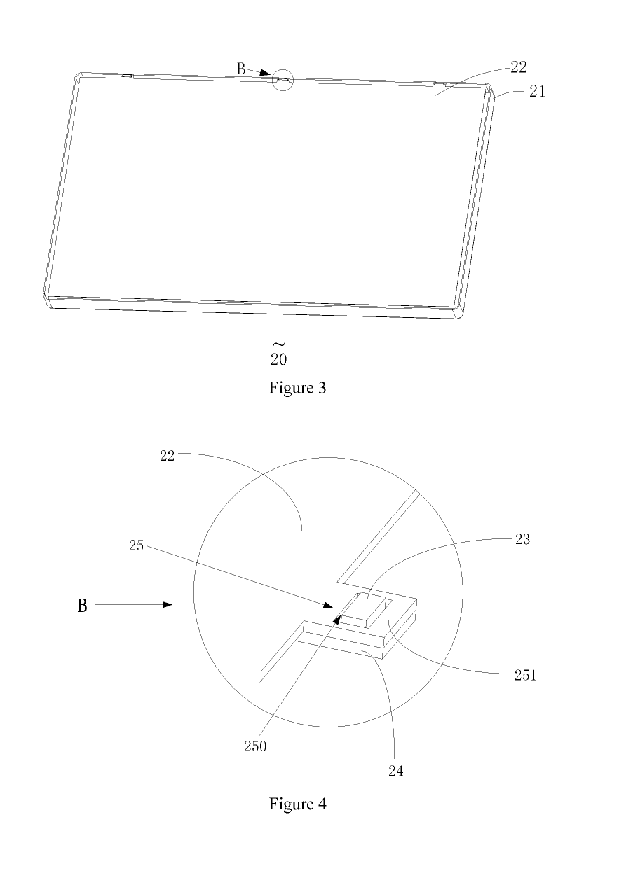

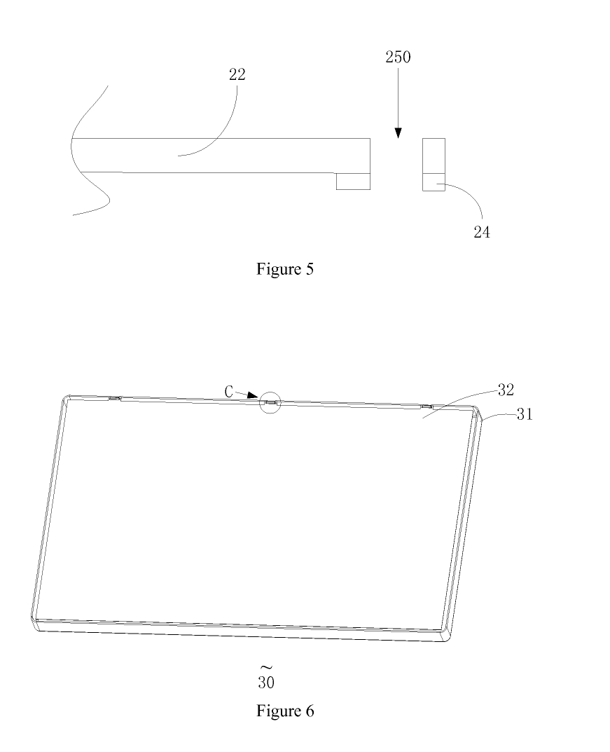

Referring to FIGS. 3, 4 and 5. FIG. 3 is an assembled and perspective view of a backlight module 20 made in accordance with a first embodiment of the present invention. FIG. 4 is an enlarged view of an encircled portion B shown in FIG. 3. FIG. 5 is a cross sectional view of an optical film and an enhancing frame after assembly in accordance with a first embodiment of the present invention.

The backlight module 20 made according to a first embodiment of the present invention includes a backboard 21, an optical film 22, a positioning device 23, and an enhancing frame 24. The positioning device 23 is arranged onto an edge of the backboard 21 and disposed above a top surface of the backboard 21. The optical film 22 is provided with a tab 25 in which a retaining opening 250 is defined therein. The retaining opening 250 can engage with the positioning device 23. The retaining opening 250 of the tab 25 has a rectangular shape, and the positioning device 23 has a cubic shape matching with retaining opening 250. Of course, the shape and configuration of the retaining opening 250 of the tab 25 and the positioning device 23 can be other suitable shape other than rectangular and cubic. In addition, the number of the positioning device 23 can be multiple as well, while the number of the tab 25 arranged along the peripheral of the optical film 22 can be also increased with respect to the number of the positioning device 23.

The enhancing frame 24 is disposed onto a bottom of the tab 25. The enhancing frame 24 is dimensioned to match with the tab 25, and it has intensity stronger than the intensity of the optical film 22. The enhancing film 22 can be made from the polyethylene terephthalate (or PET) or other material having a stronger strength. The enhancing frame 24 is attached to a top surface or bottom surface of the tab 25 by a double-side tape. Of course, other suitable measurements can be applied as well. By the provision of the enhancing frame 24 to encircle the tab 25, the intensity of the tab 25 wilt become stronger then other portions of the optical film 22, Accordingly, a hanger 251 of the tab 25 is enhanced. In other embodiment, the enhancing frame 24 can be disposed onto the top surface of the tab 25, and this can again enhance the hanger 251 of the tab 25. Accordingly, no limitation should be imposed thereon.

In addition, in other embodiment, the enhancing frame 24 can be omitted, and the tab 25 located on the peripheral of the optical film 22 can be directly replaced with other material stronger than the optical film 22. For example, the polyethylene terephthalate (or PET) used for making the enhancing frame 24 can be used.

It is understandable that the tab 25 of the optical film 22 of the backlight module 20 in accordance with the first embodiment can be enhanced through the enhancing frame 24 which has a stronger intensity as compared to other part of the optical film 22. By this arrangement, the hanger 251 of the tab 25 is intensified, and the positioning of the optical film 22 is ensured, and this is specially suitable for the design of narrow-boarder.

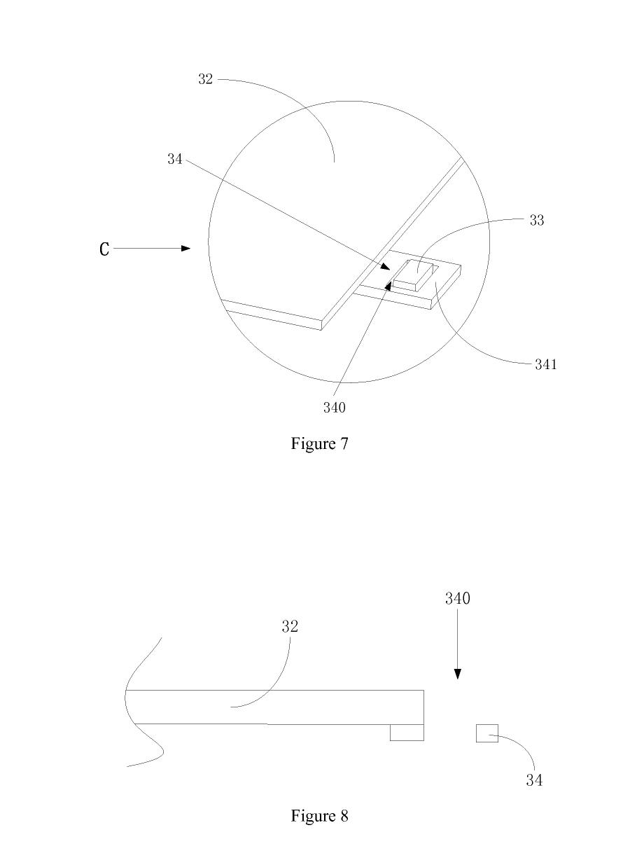

Referring to FIGS. 6, 7 and 8. FIG. 6 is an assembled view of a backlight module 30 made in accordance with a second embodiment of the present invention. FIG. 7 is an enlarged view of an encircled portion C of an optical film 32 shown in FIG. 6. FIG. 8 is a cross sectional view of a tab 32 of an optical film 32 and the tab 34 after assembly in accordance with a first embodiment of the present invention.

The backlight module 30 made according to a second embodiment of the present invention includes a backboard 31, an optical film 32, a positioning device 33, and a tab 34. The positioning device 33 is arranged onto an edge of the backboard 31 and disposed above a top surface of the backboard 31. The optical film 32 is provided with a tab 34 in which a retaining opening 340 is defined therein. The retaining opening 340 can engage with the positioning device 33. The retaining opening 340 of the tab 34 has a rectangular shape, and the positioning device 33 has a cubic shape matching with retaining opening 340. Of course, the shape and configuration of the retaining opening 340 of the tab 34 and the positioning device 23 can be other suitable shape other than rectangular and cubic. In addition, the number of the positioning device 33 can be multiple as well, while the number of the tab 34 arranged along the peripheral of the optical film 22 can be also increased with respect to the number of the positioning device 33.

The tab 34 is disposed onto a bottom of the peripheral of the optical film 32. The tab 34 has intensity stronger than the intensity of the optical film 32, The tab 34 can be made from the polyethylene terephthalate (or PET) or other material having a stronger strength. The tab 34 is attached to a top surface or bottom surface of the tab 34 by a double-side tape. Of course, other suitable measurements can be applied as well. By the provision of the tab 34 arranged to the peripheral of the optical film 32, the intensity of the tab 34 will become stronger then other portions of the optical film 32. Accordingly, a hanger 341 of the tab 34 is enhanced. In other embodiment, the tab 34 can be disposed onto the top surface of the optical film 25, and this can again enhance the hanger 341 of the tab 32. Accordingly, no limitation should be imposed thereon.

It is understandable that the enhancement along the peripheral of the optical film 32 of the backlight module 30 in accordance with the second embodiment can be enhanced through the tab 34 which has a stronger intensity as compared to other part of the optical film 32. By this arrangement, the hanger 341 of the tab 34 is intensified, and the positioning of the optical film 32 is ensured, and this is specially suitable for the design of narrow-boarder.

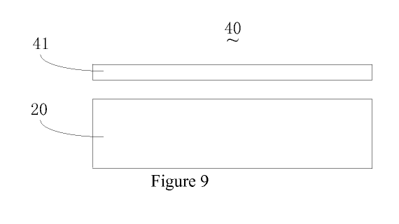

Referring to FIGS. 3, 4, 5 and 9. FIG. 9 is a cross sectional view of a liquid crystal display device 40 made in accordance with the present invention.

The liquid crystal display device 40 made in accordance with the present invention includes a display panel 41 and the backlight module 20.

The backlight module 20 is disposed under the display panel 41 so as to provide its illumination. The backlight module 20 made according to a first embodiment of the present invention includes a backboard 21, an optical film 22, a positioning device 23, and an enhancing frame 24. The positioning device 23 is arranged onto an edge of the backboard 21 and disposed above a top surface of the backboard 21. The optical film 22 is provided with a tab 25 in which a. retaining opening 250 is defined therein. The retaining opening 250 can engage with the positioning device 23. The retaining opening 250 of the tab 25 has a rectangular shape, and the positioning device 23 has a cubic shape matching with retaining opening 250. Of course, the shape and configuration of the retaining opening 250 of the tab 25 and the positioning device 23 can be other suitable shape other than rectangular and cubic. In addition, the number of the positioning device 23 can be multiple as well, while the number of the tab 25 arranged along the peripheral of the optical film 22 can be also increased with respect to the number of the positioning device 23.

The enhancing frame 24 is disposed onto a bottom of the tab 25. The enhancing frame 24 is dimensioned to match with the tab 25, and it has intensity stronger than the intensity of the optical film 22. The enhancing film 22 can be made from the polyethylene terephthalate (or PET) or other material having a stronger strength. The enhancing frame 24 is attached to a top surface or bottom surface of the tab 25 by a double-side tape, Of course, other suitable measurements can be applied as well. By the provision of the enhancing frame 24 to encircle the tab 25, the intensity of the tab 25 will become stronger then other portions of the optical film 22. Accordingly, a hanger 251 of the tab 25 is enhanced. In other embodiment, the enhancing frame 24 can be disposed onto the top surface of the tab 25, and this can. again enhance the hanger 251 of the tab 25. Accordingly, no limitation should be imposed thereon. The liquid crystal display device 40 can be a Thin Film Transistor-Liquid Crystal Display (or TFT-LCD). Of course, it can be other suitable liquid crystal device, and not limitation shall be imposed.

In addition, in other embodiment, the enhancing frame 24 can be omitted, and the tab 25 located on the peripheral of the optical film 22 can be directly replaced with other material stronger than the optical film 22. For example, the polyethylene terephthalate (or PET) used for making the enhancing frame 24 can be used. In other embodiment, the tab 25 and the enhancing frame 24 can be also omitted, and replaced with an tab having an intensity stronger than the optical film 22, and attached to a top or bottom surface of the optical film 22. The tab can be made from the polyethylene terephthalate (or PET) or other material having intensity stronger than the optical film 22. With the interengagement between the tab and the positioning device 23, the reliability of positioning of the optical film 22 can be ensured, and no limitation should be imposed.

It is understandable that the tab 25 of the optical film 22 of the backlight module 20 incorporated within the liquid crystal display device 40 in accordance with the present invention can be enhanced through the enhancing frame 24 which has a stronger intensity as compared to other part of the optical film 22. By this arrangement, the hanger 251 of the tab 25 is intensified, and the positioning of the optical film 22 is ensured, and this is specially suitable for the design of narrow-boarder.

Embodiments of the present invention have been, described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A backlight module, comprising
a backboard, an optical film, and a positioning device;
at least a positioning device being arranged on a perimeter of the backboard and extending upward form a top surface of the backboard, wherein a peripheral of the optical film is provided with at least a tab having a retaining opening defined therein to envelop onto the positioning device;
wherein the backlight module further includes an enhancing frame matched to the tab and arranged thereunder or thereabove making the tab, distant to a center of the optical film, inherited with an intensity stronger than other portions of the optical film; and
wherein the enhancing frame is attached to the top or bottom surfaces of the tab.

2. The backlight module as recited in claim 1, wherein the material used to make the enhancing frame is polyethylene terephthalate.

3. The backlight module as recited in claim 1, wherein the tab is glued to the peripheral of the optical film, and the tab has intensity stronger than the optical film.

4. The backlight module as recited in claim 3, wherein the tab is made from polyethylene terephthalate.

5. A backlight module, comprising
a backboard, an optical film, and a positioning device;
at least a positioning device being arranged on a perimeter of the backboard and extending upward form a top surface of the backboard, wherein a peripheral of the optical film is provided with at least a tab having a retaining opening defined therein to envelop onto the positioning device; and
wherein the tab, distant to a center of the optical film, inherited with intensity stronger than other portions of the optical film.

6. The backlight module as recited in claim 5, wherein the backlight module further includes an enhancing frame matched to the tab and arranged thereunder or thereabove making the tab, distant to a center of the optical film, inherited with intensity stronger than other portions of the optical film.

7. The backlight module as recited in claim 6, wherein the material used to make the enhancing frame is polyethylene terephthalate.

8. The backlight module as recited in claim 5, wherein the tab is glued to the peripheral of the optical film, and the tab has intensity stronger than the optical film.

9. The backlight module as recited in claim 8, wherein the tab is made from polyethylene terephthalate.

10. A liquid crystal display device, comprising
a displaying panel;
a backlight module disposed below the displaying panel, and including
a backboard, an optical film, and a positioning device;
at least a positioning device being arranged on a perimeter of the backboard and extending upward form a top surface of the backboard, wherein a peripheral of the optical film is provided with at least a tab having a retaining opening defined therein to envelop onto the positioning device; and
wherein the tab, distant to a center of the optical film, inherited with an intensity stronger than other portions of the optical film.

11. The liquid crystal display device as recited in claim 10, wherein the backlight module further includes an enhancing frame matched to the tab and arranged thereunder or thereabove making the tab, distant to a center of the optical film, inherited with intensity stronger than other portions of the optical film.

12. The liquid crystal display device as recited in claim 11, wherein the material used to make the enhancing frame is polyethylene terephthalate.

13. The liquid crystal display device as recited in claim 10, wherein the tab is glued to the peripheral of the optical film, and the tab has intensity stronger than the optical film.

14. The liquid crystal display device as recited in claim 13, wherein the tab is made from polyethylene terephthalate.
